(19) United States
(12) Patent Application Publication
(10) Pub. No.: US 2005/0030193 A1
(43) Pub. Date: Feb. 10, 2005

(54) Device for actuating and displaying room regulators

(75) Inventors: Jurgen Taag, Wangen (DE); Bernd Theobold, Wangen (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 10/903,030

(22) Filed: Jul. 29, 2004

(30) Foreign Application Priority Data
Aug. 7, 2003 (DE) 103 36 098.0

(51) Int. Cl. H01H 1/00

(52) U.S. Cl. 340/815.45; 307/112

(57) ABSTRACT

A device for displaying and operating a remotely adjustable room regulator has a space-saving display panel fitted with LEDs and an operating panel equipped with pushbuttons. To reduce the power consumption and thus to increase the service life of a battery for supplying voltage to the display panel, the operating mode display is effected only for a predetermined period of time from manually or program-controlled switching over into the current operating mode. Thereafter the display panel remains deactivated.

### BACKGROUND OF THE INVENTION

Field of the Invention

The invention concerns a device containing a display panel for displaying the operating modes and an actuating panel for a room regulator.

In practice rotary switches that are mostly to be actuated manually are provided for switching over between the various operating modes of a room regulator. Depending on the respective switch position, a given operating mode is active, which is indicated by the switch position. The mechanical rotary switches however are not only expensive but also require a motor for remote adjustability that is also very costly. Software-controlled regulators afford the possibility of operation by way of remote actuation or when a plurality of regulators are involved by way of a central station. Remote actuation determines the operating mode involved, and for that reason it no longer has to be the same as the local operating mode display of the rotary switch position, which gives rise to confusion and irritation. If the local intervention option is sacrificed, it is necessary to accept the fact of implementing remote actuation at the other location, which is unreasonable in particular for rooms such as bathrooms or bedrooms. In addition there is then no information about the instantaneous operating mode involved. It would be possible to envisage an optoelectronic display on the room thermostat for that purpose. To avoid major installation work, such a display would have to be battery-operated, which however would result in unreasonably short operating periods. Added to that is the fact that the available space is often not sufficient for installing an LCD display in room regulators which are as compact as possible.

### SUMMARY OF THE INVENTION

It is accordingly an object of the invention to provide a device for actuating and displaying room regulators which overcomes the above-mentioned disadvantages of the prior art devices of this general type, which saves on current and space and which is also remotely controllable.

With the foregoing and other objects in view there is provided, in accordance with the invention, a device for use in a remotely adjustable room regulator. The device contains a display panel for indicating different operating modes, and the display panel has at least one electrooptical signal generator. An operating panel has at least one button for switching over the operating modes, and without an operating mode being switched over no operating mode will be displayed. The operating panel is electrically connected to the display panel.

The room regulator can switch over between the various operating modes and the switching is effected by way of buttons and the display thereof is effected only after button actuation electrooptically, for example by way of LEDs.

The display of an operating mode exclusively on the basis of button actuation effectively provides that power is spared or the operating life of the batteries is increased in comparison with a permanent display, because the display is provided only temporarily when switching over the operating mode by way of the buttons. For the display, it is possible to associate with each operating mode its own LED that can be operated in a flashing mode. If different flashing modes can be set up, the different operating modes can be represented with a single LED because there is only ever one operating mode that is active. That correspondingly can occur by differing color emissions from an LED.

A number of options are also available in the context of the invention for implementing the operating panel. Thus, it is possible for each operating mode to have its own button associated therewith, or the operating option can be limited to two buttons, in which case one of those switches in the forward direction and the other in the rearward direction in succession through the different operating modes. The use of a single button that switches cyclically through all operating modes is particularly economic from the point of view of saving space.

Switching over the operating mode however does not require manual pressing of a button, which can also be program-controlled or remote-controlled, because all pushbuttons are normally in a rest position. It cannot therefore happen that, under remote control, an operating mode is predetermined which is in conflict with an instantaneous (rotary angle) position of a rotary switch. It can be provided in that respect that the LED associated with the operating mode is activated again for a short time, with the remotely controlled procedure of switching over the operating mode.

Other features which are considered as characteristic for the invention are set forth in the appended claims.

Although the invention is illustrated and described herein as embodied in a device for actuating and displaying room regulators, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a simplified block diagram of a room regulator;

FIG. 2 is a block circuit diagram showing principle parts of the room regulator shown in FIG. 1; and

FIG. 3 is a block diagram showing a device for cyclically switching through all operating modes by use of only one pushbutton which is to be operated manually and is a departure from the embodiment shown in FIG. 2.

### DESCRIPTION OF THE PREFERRED EMBODIMENTS

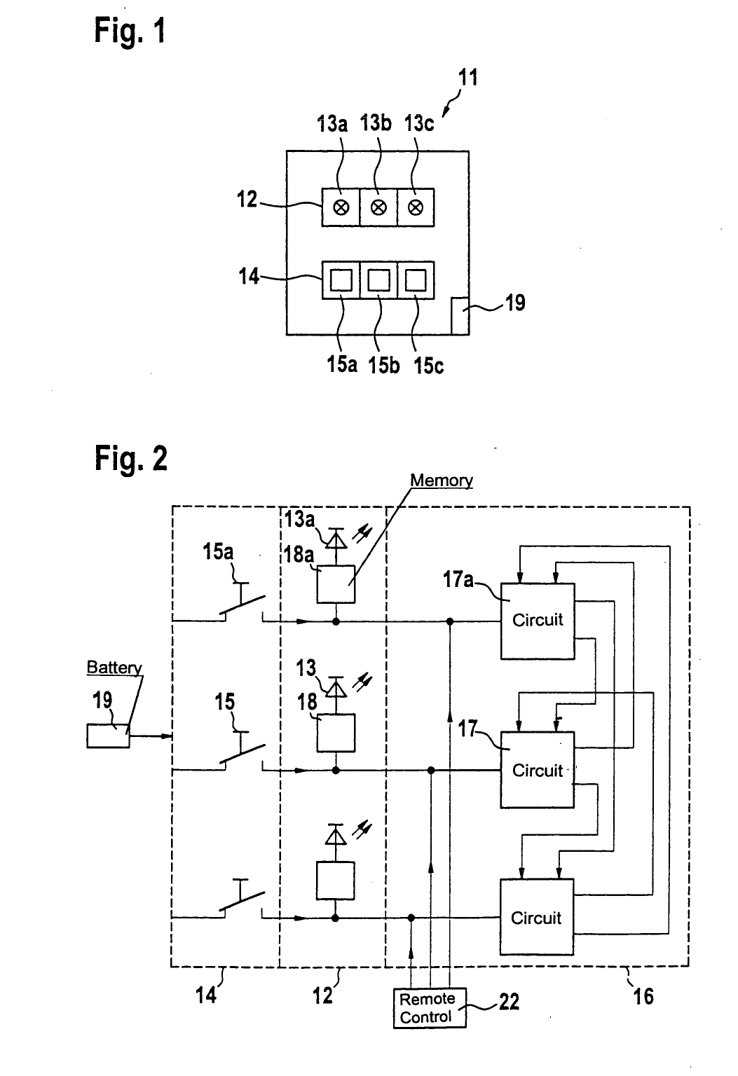

Referring now to the figures of the drawing in detail and first, particularly, to FIG. 1 thereof, there is shown a room regulator 11 that has a display panel 12 and an operating panel 14. The display panel 12 includes three LEDs 13a-13c as electrooptical signal generators, while the operating panel 14 is made up of three pushbuttons 15a-15c. The choice or selection of an operating mode a, which is affected by pressing the button 15a, is displayed by way of the corresponding LED 13a. Corresponding considerations apply for the buttons 15b and 15c for selecting the operating mode b and c respectively.

FIG. 2 shows the connection of the operating panel 14 to the display panel 12 and the continuation on to a switching region 16 for the three different operating modes a, b and c. By virtue of actuation of the pushbutton 15a, the operating condition a is activated by way of a circuit 17a and at the same time the LED 13a is supplied with power for a fixed period of time by way of a memory circuit 18a which responds to a switching pulse. Thereafter the LED 13a goes out in order not to further load the operating voltage source in the form of a battery 19. The memory circuit 18 can be configured to supply, during its active period, not a continuous output signal but an intermittent output signal, for actuation of the LED 13 that then flashes. In the case of actuation of the circuit 17 which is not manual but which is implemented by way of a remote control 22, it can also be provided that the LED 13 associated with the currently selected operating mode is briefly activated. With each actuation of the circuit 17, irrespective of whether that is by hand or electronically by way of the remote control 22, the circuits 17 which are not currently actuated are blocked, as is illustrated in FIG. 2 by the returns.

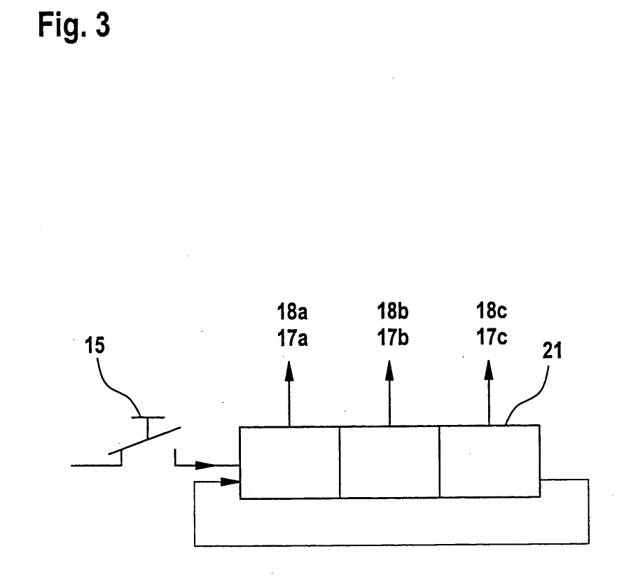

If, for reasons of space or other reasons, the operating panel 14 which is configured for three pushbuttons 15 cannot be disposed in the room regulator 11, it is possible for the operating modes a, b, c to rotate in succession and the LEDs 13 associated therewith to be called up by only one pushbutton 15, as is diagrammatically illustrated in FIG. 3 by using a shift register 21. In this case the room regulator shown in FIG. 3 can be configured in such a way that, upon first button actuation, when the display panel 12 is deactivated, the current operating mode is displayed by way of the associated LED 13. If then renewed actuation of the pushbutton 15 takes place within a fixed period of time, then the arrangement is further switched to the operating mode which follows next in the shift register 21, and that operating mode is temporarily displayed, and so forth. If, after the expiry of the period of time, no change in operating mode has occurred, it can be provided that the unchanged operating mode is displayed once again temporarily by way of the associated LED 13.

In a development of the invention it can be provided that, for the operating mode display, there is only one LED 13 which, in accordance with the currently selected operating mode a, b or c, lights up in a different color associated with the respective operating mode, or delivers a signal which is intermittent in a differing frequency.

In accordance with the invention therefore a device for display and operation of a remotely adjustable room regulator 11 has the space-saving display panel 12 fitted with LEDs 13 or other electrooptical signal generators and the operating panel 14 equipped with pushbuttons 15. To reduce the power consumption and thus to increase the service life of the battery 19 for supplying voltage to the display panel 12 the operating mode display is effected only for a predetermined period of time from manually or program-controlled switching over into the current operating mode. Thereafter the display panel 12 remains deactivated.

This application claims the priority, under 35 U.S.C. § 119, of German patent application No. 103 36 098.0, filed Aug. 7, 2003; the entire disclosure of the prior application is herewith incorporated by reference.

1. A device for use in a remotely adjustable room regulator, the device comprising:
a display panel for indicating different operating modes, said display panel having at least one electrooptical signal generator; and
an operating panel having at least one button for switching over the operating modes, and without an operating mode being switched over no operating mode will be displayed, said operating panel electrically connected to said display panel.

2. The device according to claim 1, wherein said electrooptical signal generator is a light emitting diode (LED).

3. The device according to claim 1, wherein upon actuation of said button a current operating mode is displayed.

4. The device according to claim 1, wherein the operating mode is displayed only for a predetermined period of time.

5. The device according to claim 2, wherein the operating mode is displayed by said LED flashing.

6. The device according to claim 2, wherein a display of the operating modes is effected by way of a single said LED, wherein depending on a respective operating mode said LED lights in a different color or produces a signal which is intermittent at a different frequency.

7. The device according to claim 1, wherein said at least one electrooptical signal generator is a plurality of LEDs and each of the operating modes is displayed by a separate one of said LEDs.

8. The device according to claim 1, wherein said button is one of a plurality of buttons and each of the operating modes is triggered by a separate one of said buttons.

9. The device according to claim 1, wherein the operating modes can be actuated cyclically in succession by actuation of said button.

10. The device according to claim 9, wherein upon actuation of said button within a predetermined period of time from a preceding button actuation, the operating mode is moved forward.

11. The device according to claim 10, wherein after expiry of the predetermined period of time a previously selected operating mode is temporarily displayed.

12. The device according to claim 1, further comprising a remote control device for changing the operating modes, and a brief operating mode display is triggered upon a change in operating mode by way of said remote control device.
